(19) United States
(12) Patent Application Publication
(10) Pub. No.: US 2010/0174412 A1
(43) Pub. Date: Jul. 8, 2010

(54) AIR CONDITIONER AND METHOD FOR DETECTING MALFUNCTION THEREOF

(75) Inventors: Ki Baik KWON, Seoul (KR); Sai Kee Oh, Seoul (KR); Sung Hwan Kim, Seoul (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/652,348

(22) Filed: Jan. 5, 2010

(30) Foreign Application Priority Data
Jan. 6, 2009 (KR) 10-2009-0000924
Jul. 9, 2009 (KR) 10-2009-0062721

(51) Int. Cl. G05B 15/00

(52) U.S. Cl. 700/275

(57) ABSTRACT

An air conditioner, which automatically detects malfunction, and a method for detecting a malfunction thereof are provided. The method includes: measuring an indoor unit pipe temperature around an indoor heat exchanger during operation of the air conditioner; actuating an indoor expansion valve connected to the indoor heat exchanger to a first state; and detecting whether or not a variation of the indoor unit pipe temperature is abnormal by measuring the indoor unit pipe temperature after actuating the indoor expansion valve to the first state.

This application claims the benefit of Korean Patent Application No. 10-2009-0000924 filed in Korea on Jan. 6, 2009 and Korean Patent Application No. 10-2009-0062721 filed in Korea on Jul. 9, 2009, the entire contents of which are hereby incorporated by reference for all purposes as if fully set forth herein.

### BACKGROUND OF THE INVENTION

1. Field of the Invention

The present invention relates to an air conditioner and a method for detecting a malfunction thereof, and more particularly to an air conditioner, which automatically detects a malfunction, and a method for automatically detecting a malfunction of the air conditioner.

2. Discussion of the Related Art

In general, air conditioners are apparatuses that maintain air in a designated space at a temperature and humidity level that is comfortable to humans. These air conditioners absorb heat in a designated space, or emit heat into the space, and thus maintain temperature and humidity of the space at suitable levels. Each air conditioner has an indoor unit, which absorbs heat in a designated space or emits heat into the space.

Various devices may be included in the indoor unit. Particularly, an indoor expansion valve to control refrigerant flow may be included in the indoor unit. Conventionally, to detect a malfunction of the indoor expansion valve, a technician monitors the operating state of the indoor unit.

### SUMMARY OF THE INVENTION

An advantage of the present invention is to provide an air conditioner, which automates detection of a malfunction of an indoor expansion valve, conventionally trusted only to an expert, and a method for detecting a malfunction of the air conditioner.

Another advantage of the present invention is to provide an air conditioner having a high precision in detecting a malfunction an indoor expansion valve and a method for detecting a malfunction of the air conditioner.

Still another advantage of the present invention is to provide an air conditioner that is capable of detecting a malfunction of an indoor expansion valve in both cooling and heating operations, and a method for detecting a malfunction of the air conditioner.

The advantages of the present invention are not limited to the above-mentioned advantage and other advantages that have not mentioned above will become evident to those skilled in the art from the following description.

To achieve the above advantages, there is provided a method for detecting a malfunction of an air conditioner according to an exemplary embodiment of the present invention, including measuring an indoor unit pipe temperature around an indoor heat exchanger during operation of the air conditioner; actuating an indoor expansion valve connected to the indoor heat exchanger to a first state; and detecting whether or not a variation of the indoor unit pipe temperature is abnormal by measuring the indoor unit pipe temperature after actuating the indoor expansion valve to the first state.

To achieve the above advantages, there is provided an air conditioner according to an exemplary embodiment of the present invention, including an indoor heat exchanger including a refrigerant that exchanges heat with indoor air; an indoor expansion valve connected to the indoor heat exchanger to control refrigerant flow; and a control unit that detects whether or not the indoor expansion valve is malfunctioning by measuring an indoor unit pipe temperature to the indoor heat exchanger while actuating the indoor expansion valve to a first state.

Detailed matters of other exemplary embodiments will be incorporated by the following description and drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic view of an air conditioner in accordance with one embodiment of the present invention;

FIG. 2 is a block diagram of the air conditioner in accordance with the embodiment of the present invention;

FIGS. 3(a) to 3(c) are graphs illustrating temperature variations caused by the opening and closing of an indoor expansion valve of the air conditioner during a cooling operation in accordance with an embodiment of the present invention;

FIGS. 4(a) and 4(b) are graphs illustrating temperature variations caused by the opening and closing of the indoor expansion valve of the air conditioner during a heating operation in accordance with an embodiment of the present invention;

FIG. 5 is a flow chart illustrating a method for detecting a malfunction of an air conditioner in accordance with an embodiment of the present invention; and

FIG. 6 is a flow chart illustrating a method for detecting a malfunction of the indoor expansion valve of the air conditioner in accordance with an embodiment of the present invention.

### DETAILED DESCRIPTION OF THE PREFERRED EMBODIMENTS

The advantages and features of the present invention, and the way of attaining them, will become apparent with reference to embodiments described below in conjunction with the accompanying drawings. However, the present invention is not limited to the embodiments disclosed below and will be embodied in a variety of different forms; rather, these embodiments are provided so that this disclosure will be thorough and complete, and will fully convey the scope of the present invention to those skilled in the art, and the scope of the present invention will be defined by the appended claims. Like reference numerals refer to like elements throughout the specification.

An air conditioner and a method for detecting a malfunction of the air conditioner in accordance with embodiments of the present invention will hereinafter be described in detail with reference to the accompanying drawings.

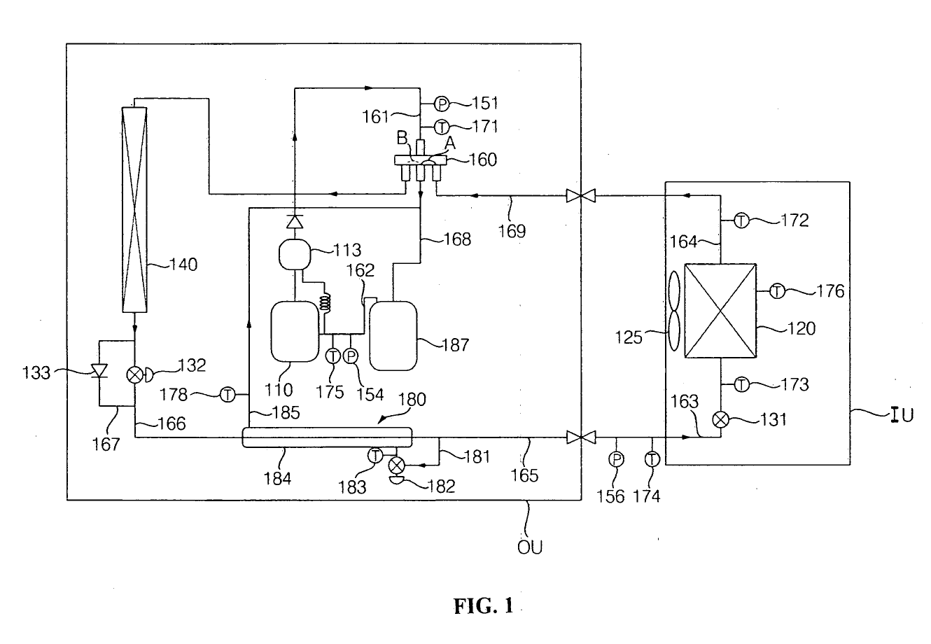

FIG. 1 is a schematic view of an air conditioner in accordance with an embodiment of the present invention.

The air conditioner may include an outdoor unit OU and an indoor unit IU.

The outdoor unit OU includes a compressor 110, an outdoor heat exchanger 140, an outdoor expansion valve 132, and a supercooler 180. The air conditioner may include one outdoor unit OU or a plurality of outdoor units OU.

The compressor 110 compresses an incoming refrigerant from a low-temperature and low-pressure state into a high-temperature and high-pressure state. The compressor 110 may include various structures, and may employ an inverter-type compressor or a constant speed compressor. A discharge temperature sensor 171 and a discharge pressure sensor 151 are installed on a discharge pipe 161 of the compressor 110. Further, a suction temperature sensor 175 and a suction pressure sensor 154 are installed on a suction pipe 162 of the compressor 110.

Although the outdoor unit OU of this embodiment includes one compressor 110, the present invention is not limited thereto. That is, the outdoor unit OU may include a plurality of compressors, and may include an inverter-type compressor and a constant speed compressor simultaneously.

In order to prevent refrigerant in a liquid state from being fed into the compressor 110, an accumulator 187 may be installed on the suction pipe 162 of the compressor 110. Further, an oil separator 113 may be installed on the discharge pipe 161 of the compressor 110 so as to collect oil from the refrigerant discharged from the compressor 110.

A four-way valve 160 is a flow switching valve to switch between cooling and heating operations. The four-way valve 160 guides the refrigerant, compressed by the compressor 110, to the outdoor heat exchanger 140 during the cooling operation, and to an indoor heat exchanger 120 during the heating operation. The four-way valve 160 is in an A state in the cooling operation, and is in a B state in the heating operation. The arrows indicating the refrigerant flow in FIG. 1 illustrate a cooling operation with the four-way valve 160 in the A state.

The outdoor heat exchanger 140 is disposed in an outdoor space, and the refrigerant passing through the outdoor heat exchanger 140 exchanges heat with outdoor air. The outdoor heat exchanger 140 serves as a condenser in the cooling operation and serves as an evaporator in the heating operation.

The outdoor expansion valve 132 controls the incoming refrigerant flow in the heating operation, and is installed on an inlet pipe 166 connecting a liquid refrigerant pipe 165 and the outdoor heat exchanger 140. Further, a first bypass pipe 167 to allow the refrigerant to bypass the outdoor expansion valve 132 is installed on the inlet pipe 166, and a check valve 133 is installed on the first bypass pipe 167 to allow refrigerant to only flow in one direction.

The check valve 133 causes the refrigerant to flow from the outdoor heat exchanger 140 to the indoor unit IU in the cooling operation, but shuts off the flow of the refrigerant in the heating operation.

The supercooler 180 includes a supercooling heat exchanger 184, a second bypass pipe 181, a supercooling expansion valve 182, and a discharge pipe 185. The supercooling heat exchanger 184 is disposed on the inlet pipe 166. In the cooling operation, the second bypass pipe 181 serves to cause the refrigerant discharged from the supercooling heat exchanger 184 to be fed into the supercooling expansion valve 182.

The supercooling expansion valve 182 is disposed on the second bypass pipe 181. The supercooling expansion valve 182 controls the refrigerant flow in a liquid state fed into the second bypass pipe 181 to lower the pressure and temperature of the refrigerant, and then feeds the refrigerant in the low-pressure and low-temperature state into the supercooling heat exchanger 184. The supercooling expansion valve 182 may employ various types of valves, but the present embodiment employs a linear expansion valve. A supercooling temperature sensor 183 to sense the temperature of the refrigerant controlled by the supercooling expansion valve 182 may be installed on the second bypass pipe 181.

During the cooling operation, the condensed refrigerant passing through the outdoor heat exchanger 140 is supercooled by exchanging heat with the refrigerant in the low-temperature state fed through the second bypass pipe 181 in the supercooling heat exchanger 184, and then is fed to the indoor unit IU.

The refrigerant passing through the second bypass pipe 181 is fed to the accumulator 187 through the discharge pipe 185, after undergoing heat-exchange in the supercooling heat exchanger 184. A discharge pipe temperature sensor 178 to measure the temperature of the refrigerant fed to the accumulator 187 is installed on the discharge pipe 185.

A liquid pipe temperature sensor 174 and a liquid pipe pressure sensor 156 are installed on the liquid pipe 165 connecting the supercooler 180 and the indoor unit IU.

In an embodiment of the air conditioner in accordance with the present invention, the indoor unit IU may include an indoor heat exchanger 120, an indoor air blower 125, and an indoor expansion valve 131. The air conditioner may include one indoor unit IU or a plurality of indoor units IU.

The indoor heat exchanger 120 is disposed in an indoor space, and the refrigerant passing through the indoor heat exchanger 120 exchanges heat with indoor air. The indoor heat exchanger 120 serves as an evaporator in the cooling operation, and serves as a condenser in the heating operation. An indoor temperature sensor 176 to measure an indoor temperature is installed in the indoor heat exchanger 120.

The indoor expansion valve 131 controls the incoming refrigerant flow in the cooling operation. The indoor expansion valve 131 is installed on an indoor inlet pipe 163 of the indoor unit IU. The indoor expansion valve 131 may employ various types of valves, but the present embodiment employs a linear expansion valve.

Preferably, the indoor expansion valve 131 is opened to a set position that restricts the flow during in the cooling operation and is completely opened during the heating operation. The indoor expansion valve 131 may be closed or opened in order to detect a malfunction during the cooling operation or the heating operation. Here, the closing of the indoor expansion valve 131 does not mean a complete physical closing, but means a position of the indoor expansion valve 131 such that the refrigerant does not flow through the indoor expansion valve 131.

A malfunction of the indoor expansion valve 131 may be detected if the initial open state of the indoor expansion valve 131 is incorrectly determined. Therefore, when an indoor expansion valve 131 malfunction is detected, the indoor expansion valve 31 may be initialized. The indoor expansion valve 131 is initialized by completely opening the indoor expansion valve 131 and then completely closing the indoor expansion valve 131. Other various methods of initializing the open state of the indoor expansion valve 131 may also be used.

An indoor inlet pipe temperature sensor 173 may be installed on the indoor inlet pipe 163. The indoor inlet pipe temperature sensor 173 may be installed between the indoor heat exchanger 120 and the indoor expansion valve 131. Further, an indoor outlet pipe temperature sensor 172 may be installed on an indoor outlet pipe 164.

The flow of the refrigerant during the cooling operation of the above-described air conditioner is as follows.

The refrigerant in a high-temperature and high-pressure vapor state discharged from the compressor 110 is fed into the outdoor heat exchanger 140 via the four-way valve 160. In the outdoor heat exchanger 140, the refrigerant exchanges heat with outdoor air, thus being condensed. The refrigerant discharged from the outdoor heat exchanger 140 is fed to the supercooler 180 through the completely open outdoor expansion valve 132 and the bypass pipe 133. The refrigerant fed to the supercooler 180 is supercooled by the supercooling heat exchanger 184, and then is fed to the indoor unit IU.

A part of the refrigerant supercooled by the supercooling heat exchanger 184 is controlled by the supercooling expansion valve 182. A part of the refrigerant supercooled by the supercooling heat exchanger 184 is fed to the accumulator 187.

The refrigerant fed to the indoor unit IU is controlled by the indoor expansion valve 131 that is open to a set open state, and the refrigerant then exchanges heat with indoor air in the indoor heat exchanger 120 by being evaporated. The evaporated refrigerant is then fed into the compressor 110 via the four-way valve 160 and the accumulator 187.

The flow of the refrigerant during the heating operation of the above-described air conditioner is as follows.

The refrigerant in a high-temperature and high-pressure vapor state discharged from the compressor 110 is fed into the indoor unit IU via the four-way valve 160. The indoor expansion valve 131 of the indoor unit IU is completely open. Therefore, the refrigerant fed from the indoor unit IU is controlled by the outdoor expansion valve 132, and then exchanges heat with outdoor air in the outdoor heat exchanger 140 by being evaporated. The evaporated refrigerant is then fed into the suction pipe 162 of the compressor 110 via the four-way valve 160 and the accumulator 187.

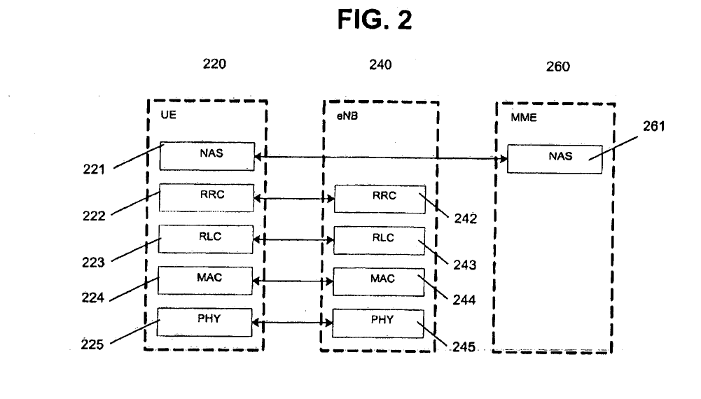

FIG. 2 is a block diagram of the air conditioner in accordance with an embodiment of the present invention.

The indoor outlet pipe temperature sensor 172 measures the temperature of the refrigerant discharged from the indoor heat exchanger 120. The indoor outlet pipe temperature sensor 172 is installed on the indoor outlet pipe 164.

The indoor inlet pipe temperature sensor 173 measures the temperature of the refrigerant fed to the indoor heat exchanger 120. The indoor inlet pipe temperature sensor 173 is installed on the indoor inlet pipe 163 connecting the indoor heat exchanger 120 and the indoor expansion valve 131.

The indoor temperature sensor 176 measures the temperature of indoor air. The indoor temperature sensor 176 is installed in the indoor unit IU.

A control unit 190 detects whether or not the indoor expansion valve 131 is malfunctioning based on indoor unit pipe temperatures measured while opening and closing the indoor expansion valve 131. The indoor unit pipe temperature is a temperature measured by the indoor outlet pipe temperature sensor 172 or the indoor inlet pipe temperature sensor 173. The indoor unit pipe temperature may be the average value of the temperature measured by the indoor outlet pipe temperature sensor 172 and the temperature measured by the indoor inlet pipe temperature sensor 173.

The control unit 190 detects abnormalities in the indoor unit pipe temperature when the indoor expansion valve 131 is opened and closed. The control unit 190 detects whether or not the indoor expansion valve 131 is malfunctioning by analyzing the variation in the indoor unit pipe temperature as the indoor expansion valve 131 is switched from the open state to the closed state. The control unit 190 then compares the measured variation of the indoor unit pipe temperature with the known variation of the indoor unit pipe temperature in a normal state. Further, the control unit 190 detects whether or not the indoor expansion valve 131 is malfunctioning by analyzing the variation in the indoor unit pipe temperature as the indoor expansion valve 131 is switched from the closed state to the open state. The control unit 190 then compares the measured variation of the indoor unit pipe temperature with the known variation of the indoor unit pipe temperature in the normal state.

The control unit 190 may detect abnormalities in the difference between the indoor unit pipe temperature and an indoor air temperature when the indoor expansion valve 131 is opened and closed. The control unit 190 detects whether or not the indoor expansion pipe 131 is malfunctioning by analyzing the variation in the difference between the indoor unit pipe temperature and the indoor air temperature as the indoor expansion valve 131 is switched from the open state to the closed state. The control unit 190 then compares the measured variation of the difference between the indoor unit pipe temperature and the indoor air temperature with the known variation of the difference between the indoor unit pipe temperature and the indoor air temperature in a normal state.

If the control unit 190 detects a malfunction of the indoor expansion valve 131, the control unit 190 may initialize the indoor expansion valve 131 because the malfunction may be due to an incorrect determination of the initial open state of the indoor expansion valve 131. The control unit 190 may then again determine whether or not the indoor expansion valve 131 is malfunctioning. The initialization of the indoor expansion valve 131 is as described above.

The current open state of the indoor expansion valve 131 may be lost by the control unit 190, such as when the power is turned off and then turned on. So while the control unit 90 indicates that the indoor expansion valve 131 is closed, the indoor expansion valve 131 may be substantially open. Thus, the control unit 190 detects that the indoor expansion valve 130 is malfunctioning. Therefore, the control unit 190 initializes the indoor expansion valve and then determines again whether or not the indoor expansion valve 131 is malfunctioning.

If the control unit 190 detects that the indoor expansion valve 131 is malfunctioning after the initialization of the indoor expansion valve 131, the control unit 190 may store an indication that the indoor expansion valve 131 is malfunctioning and/or provide a warning to the user by an alarm unit.

If the control unit 190 determines that the indoor expansion valve 131 is malfunctioning, the alarm unit 193 communicates the fact that the indoor expansion valve 131 is malfunctioning to a user either visually or through sound. The alarm unit 193 may inform other systems of the fact that the indoor expansion valve 131 is malfunctioning through a network.

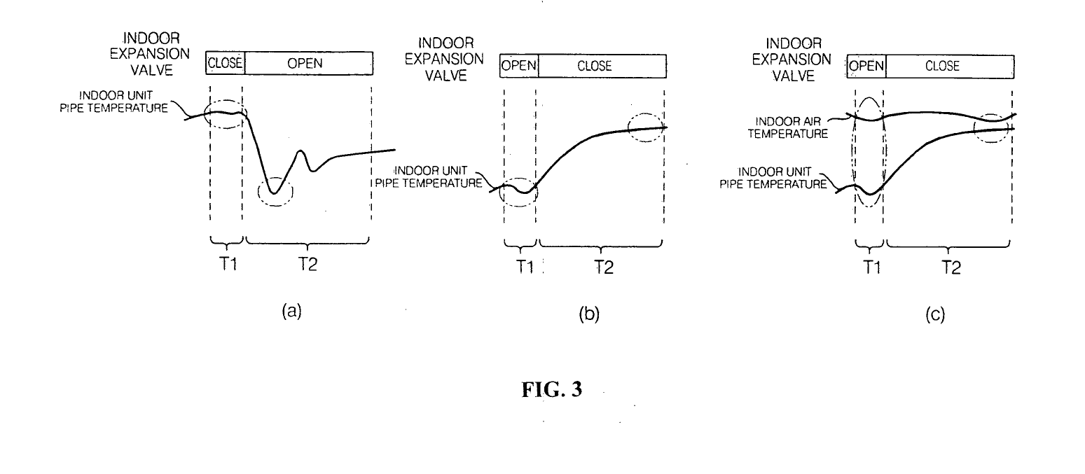

FIGS. 3(a) to 3(c) are graphs illustrating temperature variations when an indoor expansion valve switches between closed and open during the cooling operation of the air conditioner in accordance with an embodiment of the present invention.

FIG. 3(a) illustrates the variation of the indoor unit pipe temperature when the indoor expansion valve 131 switches from closed to open during the cooling operation. The control unit 190 detects whether or not the indoor expansion valve 131 is operating normally by using a difference of the indoor unit pipe temperatures during a time period T1 and a time period T2.

If the indoor expansion valve 131 is initially partially or completely open due to a malfunction, a low-temperature refrigerant flows. Thus, although the control unit 190 opens the indoor expansion valve 131, a variation in the indoor unit pipe temperature is not greater than the variation during the normal operation of the indoor expansion valve 131. Further, if the indoor expansion valve 131 is initially closed but is not opened due to a malfunction and although the control unit 190 opens the indoor expansion valve 131, the indoor expansion valve 131 is not substantially opened and thus the low-temperature refrigerant does not flow. Therefore, the variation of the indoor unit pipe temperature is not greater than the variation during the normal operation of the indoor expansion valve 131. Therefore, if the difference of the indoor unit pipe temperatures between the time period T1 and the time period T2 is smaller than a predetermined reference value, the control unit 190 determines that the indoor expansion valve 131 is malfunctioning.

FIG. 3(b) illustrates the variation of the indoor unit pipe temperature when the indoor expansion valve 131 switches from open to closed during the cooling operation. The control unit 190 detects whether or not the indoor expansion valve 131 is operating normally by using the difference of the indoor unit pipe temperatures during a time period T1 and a time period T2.

If the indoor expansion valve 131 is initially partially or completely closed due to a malfunction, the low-temperature refrigerant does not flow. Thus, although the control unit 190 closes the indoor expansion valve 131, a variation in the indoor unit pipe temperature is not greater than the variation during the normal operation of the indoor expansion valve 131. Further, if the indoor expansion valve 131 is initially opened but is not closed or is partially closed due to a malfunction and although the control unit 190 closes the indoor expansion valve 131, the indoor expansion valve 131 is not substantially closed and thus the low-temperature refrigerant flows. Therefore, the variation of the indoor unit pipe temperature is not greater than the variation during the normal operation of the indoor expansion valve 131. Therefore, if the difference of the indoor unit pipe temperatures between the time period T1 and the time period T2 is smaller than a predetermining reference value, the control unit 190 determines that the indoor expansion valve 131 is malfunctioning.

FIG. 3(c) illustrates the variation of the indoor unit pipe temperature when the indoor air temperature when the indoor expansion valve 131 switches from open to closed during the cooling operation. The control unit 190 detects whether or not the indoor expansion valve 131 is operating normally by using a difference between the indoor unit pipe temperatures and the indoor air temperature during the time period T1 and the time period T2.

If the indoor expansion valve 131 is initially partially or completely closed due to a malfunction, the low-temperature refrigerant does not flow. Thus, a difference between the indoor unit pipe temperature and the indoor air temperature is smaller than that during normal operation of the indoor expansion valve 131. Further, if the indoor expansion valve 131 is initially opened but is not closed or is partially closed due to a malfunction and although the control unit 190 closes the indoor expansion valve 131, the indoor expansion valve 131 is not substantially closed and thus the low-temperature refrigerant flows. Thus, a difference between the indoor unit pipe temperature and the indoor air temperature is greater than that during the normal state of the indoor expansion valve 131. Therefore, if the difference of the indoor unit pipe temperature and the indoor air temperature during the time period T1 and the time period T2 is smaller or greater than a predetermined reference value, the control unit 190 determines that the indoor expansion valve 131 is malfunctioning.

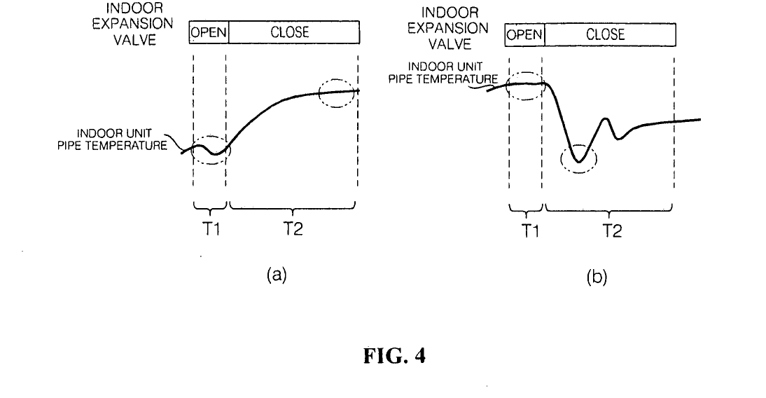

FIGS. 4(a) and 4(b) are graphs illustrating temperature variations when the indoor expansion valve switches between closed and open during the heating operation of the air conditioner in accordance with an embodiment of the present invention.

FIG. 4(a) illustrates the variation of the indoor unit pipe temperature when the indoor expansion valve 131 switches from closed to open during the heating operation. The control unit 190 detects whether or not the indoor expansion valve 131 is operating normally using a difference of the indoor unit pipe temperatures during a time period T1 and a time period T2.

If the indoor expansion valve 131 is initially partially or completely open due to a malfunction, a high-temperature refrigerant flows. Thus, although the control unit 190 opens the indoor expansion valve 131, a variation in the indoor unit pipe temperature is not greater than the variation during the normal operation of the indoor expansion valve 131. Further, if the indoor expansion valve 131 is initially closed but is not opened due to a malfunction and although the control unit 190 opens the indoor expansion valve 131, the indoor expansion valve 131 is not substantially opened and thus the high-temperature refrigerant does not flow. Therefore, the variation of the indoor unit pipe temperature is not greater than the variation during the normal operation of the indoor expansion valve 131. Therefore, if the difference of the indoor unit pipe temperatures between the time period T1 and the time period T2 is smaller than a predetermined reference value, the control unit 190 determines that the indoor expansion valve 131 is malfunctioning.

FIG. 4(b) illustrates the variation of the indoor unit pipe temperature when the indoor expansion valve 131 switches from open to closed during the heating operation. The control unit 190 detects whether or not the indoor expansion valve 131 is operating normally by using the difference of the indoor unit pipe temperature during a time period T1 and the time period T2.

If the indoor expansion valve 131 is initially partially or completely closed due to a malfunction, the high-temperature refrigerant does not flow. Thus, although the control unit 190 closes the indoor expansion valve 131, a variation in the indoor unit pipe temperature is not greater than the variation during the normal operation of the indoor expansion valve 131. Further, if the indoor expansion valve 131 is initially opened but is not closed or is partially closed due to a malfunction and although the control unit 190 closes the indoor expansion valve 131, the indoor expansion valve 131 is not substantially closed and thus the high-temperature refrigerant flows. Therefore, the variation of the indoor unit pipe temperature is not greater than the variation during the normal operation of the indoor expansion valve 131. Therefore, if the difference of the indoor unit pipe temperatures between the time period T1 and the time period T2 is smaller than a predetermined reference value, the control unit 190 determines that the indoor expansion valve 131 is malfunctioning.

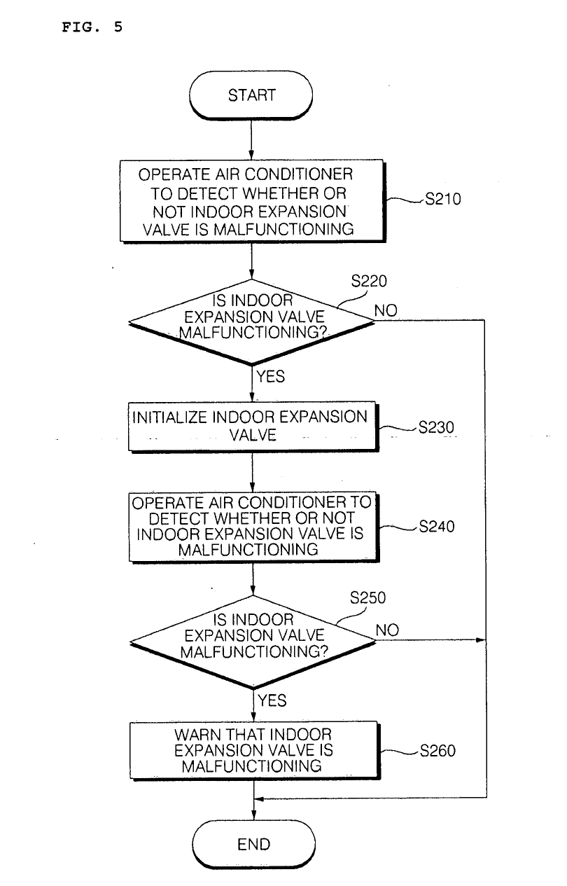

FIG. 5 is a flow chart illustrating a method for detecting a malfunction of an air conditioner in accordance with an embodiment of the present invention.

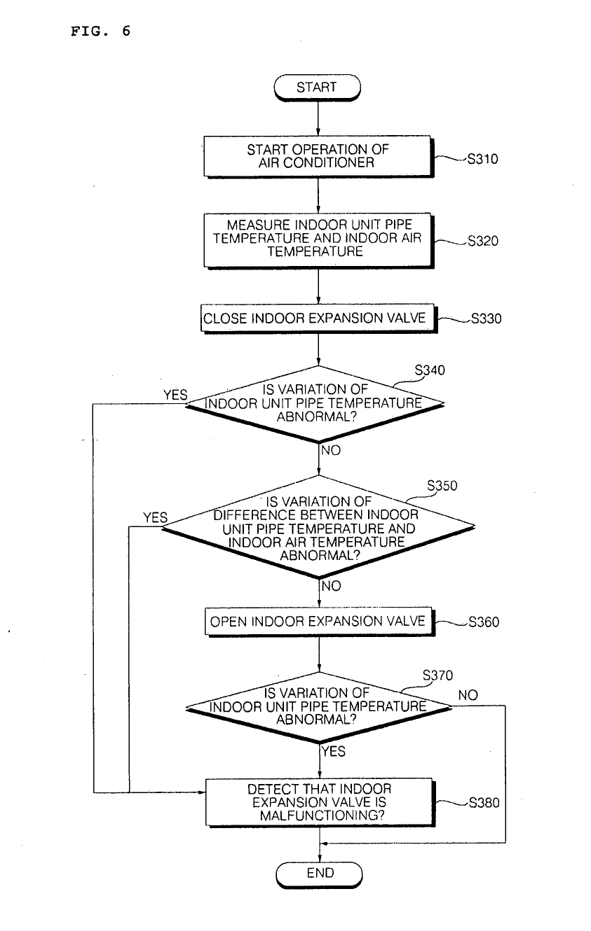

First, the air conditioner is operated to detect whether or not the indoor expansion valve 131 is malfunctioning (S210). In order to detect whether or not the indoor expansion valve 131 is malfunctioning, the control unit 190 performs a cooling operation or a heating operation and measures the indoor unit pipe temperature while opening and closing the indoor expansion valve 131. A detailed description of the above detection will be described later with reference to FIG. 6.

Thereafter, any malfunction of the indoor expansion valve 131 is detected (S220). The control unit 190 detects whether or not a variation of the indoor unit pipe temperature is abnormal when the indoor expansion valve 131 is opened and closed. Further, the control unit 190 may detect whether or not a variation of a difference between the indoor unit pipe temperature and the indoor air temperature is abnormal when the indoor expansion valve 131 is opened and closed.

If the control unit 190 detects an indoor expansion valve 131 malfunction, the indoor expansion valve 131 may be initialized (S230). If the control unit 190 detects an indoor expansion valve 131 malfunction, it is preferable that the control unit 190 initialize the indoor expansion valve 131. Because the control unit 190 may detect that the indoor expansion valve 131 is malfunctioning due to an incorrect determination of the initial open state of the indoor expansion valve 131, the control unit 190 may initialize the indoor expansion valve 131 and then detect again whether or not the indoor expansion valve 131 is malfunctioning. The initialization of the indoor expansion valve 131 means initialization of the open state of the indoor expansion valve 131 by completely opening the indoor expansion valve 131 and then completely closing the indoor expansion valve 131. Other various methods of initializing the open state of the indoor expansion valve 131 may be used.

Next, the air conditioner is operated again to detect whether or not the indoor expansion valve 131 is malfunctioning (S240), and the control unit 190 performs the cooling operation or the heating operation of the air conditioner and measures the indoor unit pipe temperature while opening and closing the indoor expansion valve 131.

Thereafter, any malfunction of the indoor expansion valve 131 is re-detected (S250), and the control unit 190 detects whether or not a variation of the indoor unit pipe temperature or a variation of a difference between the indoor unit pipe temperature and the indoor air temperature is abnormal when the indoor expansion valve 131 is opened and closed.

If the control unit 190 detects an indoor expansion valve 131 malfunction, a warning indicating that the indoor expansion valve 131 is malfunctioning is given to the user (S260). If the control unit 190 detects an indoor expansion valve 131 malfunction even after the initialization of the indoor expansion valve 131, the control unit 190 may store an indication that the indoor expansion valve 131 is malfunctioning and/or provide a warning to the user by the alarm unit 193. The alarm unit 193 may display the fact that the indoor expansion valve 131 is malfunctioning to the user visually or through sound.

FIG. 6 is a flow chart illustrating a method for detecting a malfunction of the indoor expansion valve of an air conditioner in accordance with an embodiment of the present invention.

FIG. 6 illustrates in detail the operation of the air conditioner to detect whether or not the indoor expansion valve 131 is malfunctioning (S210, 5240) and the detection whether or not the indoor expansion valve 131 is malfunctioning (S220, S250).

First, the air conditioner is started (S310). The air conditioner may be in either cooling mode or a heating mode. Further, the air conditioner may be operated to detect whether or not the indoor expansion valve 131 is malfunctioning or may be operated normally to cool or heat an indoor space.

Next, an indoor unit pipe temperature and an indoor air temperature are measured (S320). In order to detect whether or not the indoor expansion valve 131 is malfunctioning, the control unit 190 measures and tracks the indoor unit pipe temperature and the indoor air temperature.

The indoor unit pipe temperature is a temperature measured by the indoor outlet pipe temperature sensor 172 or the indoor inlet pipe temperature sensor 173. The indoor unit pipe temperature may be the average value of the temperature measured by the indoor outlet pipe temperature sensor 172 and the temperature measured by the indoor inlet pipe temperature sensor 173. The indoor air temperature is a temperature of indoor air measured by the indoor temperature sensor 176.

The indoor expansion valve 131 is opened to the set open state during the cooling operation, and is completely opened during the heating operation. Therefore, in order to detect whether or not the indoor expansion valve 131 is malfunctioning in the cooling operation, the indoor expansion valve 131 may be completely opened.

The control unit 190 closes the opened indoor expansion valve 131 (S330). When the control unit 190 closes the indoor expansion valve 131, the indoor outlet pipe temperature sensor 172 or the indoor inlet pipe temperature sensor 173 continuously measures the indoor unit pipe temperature, and the indoor temperature sensor 176 continuously measures the indoor air temperature. Further, the control unit 190 continuously tracks the indoor unit pipe temperature and the indoor air temperature.

The control unit 190 detects whether or not the indoor unit pipe temperature is abnormal (S340). The control unit 190 detects whether or not the indoor unit pipe temperature is abnormal by comparing a variation of the indoor unit pipe temperature during the open state of the indoor expansion valve 131 to the closed state of the indoor expansion valve 131 with that in the normal state.

If the control unit detects that the indoor unit pipe temperature is not abnormal, the control unit 190 detects whether or not a variation of a difference between the indoor unit pipe temperature and the indoor air temperature is abnormal (S350). The control unit 190 detects whether or not the variation of the difference between the indoor unit pipe temperature and the indoor air temperature is abnormal by comparing the variation of the difference between the indoor unit pipe temperature and the indoor air temperature during the open state of the indoor expansion valve 131 to the closed state of the indoor expansion valve 131 with that during the normal state.

The operation S350 may be performed if it is detected that the indoor unit pipe temperature is abnormal during the operation S340. In this case, precision in detecting whether or not the indoor expansion valve 131 is malfunctioning is increased.

If the control unit detects that the indoor unit pipe temperature is abnormal, the control unit 190 detects that the indoor expansion valve 131 is malfunctioning (S380).

If the control unit detects that the variation of the difference between the indoor unit pipe temperature and the indoor air temperature is not abnormal, the control unit 190 opens the indoor expansion valve 131 (S360). When the control unit 190 opens the indoor expansion valve 131, the indoor outlet pipe temperature sensor 172 or the indoor inlet pipe temperature sensor 173 continuously measures the indoor unit pipe temperature, and the indoor temperature sensor 176 continuously measures the indoor air temperature. Further, the control unit 190 continuously tracks the indoor unit pipe temperature and the indoor air temperature.

The operation 5360 may be performed if the control unit detects that the variation of the difference between the indoor unit pipe temperature and the indoor air temperature is abnormal during operation S350. In this case, the precision in detecting whether or not the indoor expansion valve 131 is malfunctioning is increased.

If the control unit 190 detects that the variation of the difference between the indoor unit pipe temperature and the indoor air temperature is abnormal, the control unit 190 detects that the indoor expansion valve 131 is malfunctioning (S380).

The control unit 190 detects whether or not the indoor unit pipe temperature is abnormal (S370). The control unit 190 detects whether or not the indoor unit pipe temperature is abnormal by comparing a variation of the indoor unit pipe temperature during the closed state of the indoor expansion valve 131 to the open state of the indoor expansion valve 131 with that during the normal state.

If the control unit 190 detects that the indoor unit pipe temperature is abnormal, the control unit 190 detects that the indoor expansion valve 131 is malfunctioning (S380).

It should be noted that the method and apparatus of the present invention may continuously determine if there is a malfunction of the indoor expansion valve. This would be accomplished by continuously measuring the temperatures in the indoor unit and continuously determining if an abnormality is detected. Also, the determination may be made only when specifically requested, for example by a user or a piece of test equipment. It could also be done periodically at a predetermined interval.

It will be understood by those skilled in the art that example embodiments can be implemented in other specific forms without changing the technical spirit or essential features of the present invention. Therefore, it should be noted that the forgoing embodiments are merely illustrative in all aspects and are not to be construed as limiting the invention. The scope of the invention is defined by the appended claims rather than the detailed description of the invention. All changes or modifications or their equivalents made within the meanings and scope of the claims should be construed as falling within the scope of the invention.

According to the air conditioner and method for detecting a malfunction of the air conditioner of the present invention, one or more effects as follows may be achieved.

First, detection of a malfunction of an indoor expansion valve, conventionally trusted only to an expert, is automated, thereby reducing wasted time and manpower.

Second, the precision in detecting a malfunction of the indoor expansion valve, which conventionally relies on the proficiency of the expert, is improved.

Third, detection of a malfunction of the indoor expansion valve is possible in both cooling and heating operations.

Fourth, a possibility of detecting that the indoor expansion valve is malfunctioning due to incorrect recognition of the initial open state of the indoor expansion valve is eliminated, thereby improving the precision in detection of a malfunction of the indoor expansion valve.

Fifth, the possibility of identifying a normal indoor unit as a malfunctioning indoor unit is reduced.

The effects of the present invention are not limited to the above-mentioned effects, and other effects not mentioned above can be clearly understood from the definitions in the claims by one skilled in the art.

What is claimed is:

1. A method for detecting a malfunction of an air conditioner comprising:
measuring an indoor unit pipe temperature around an indoor heat exchanger during operation of the air conditioner;
actuating an indoor expansion valve connected to the indoor heat exchanger to a first state; and
detecting whether or not a variation of the indoor unit pipe temperature is abnormal by measuring the indoor unit pipe temperature after actuating the indoor expansion valve to the first state.

2. The method according to claim 1, wherein the indoor unit pipe temperature is a temperature of an indoor outlet pipe of the indoor heat exchanger.

3. The method according to claim 1, wherein the indoor unit pipe temperature is a temperature of an indoor inlet pipe of the indoor heat exchanger.

4. The method according to claim 1, further comprising:
measuring an indoor air temperature;
calculating a temperature difference between the indoor unit pipe and indoor air; and
detecting whether or not a variation the temperature difference is abnormal by measuring the indoor unit pipe temperature after actuating the indoor expansion valve to the first state.

5. The method according to claim 1, wherein measuring the indoor unit pipe temperature includes measuring both the temperature of an indoor inlet pipe and of an indoor outlet pipe of the heat exchanger.

6. The method according to claim 1, further comprising:
actuating the indoor expansion valve to a second state; and
detecting whether or not a variation of the indoor unit pipe temperature is abnormal by measuring the indoor unit pipe temperature after the opening of the indoor expansion valve.

7. The method according to claim 1, further comprising warning that the indoor expansion valve is malfunctioning, if it is detected that the variation of the indoor unit pipe temperature is abnormal.

8. The method according to claim 1, further comprising initializing the indoor expansion valve, if it is detected that the variation of the indoor unit pipe temperature is abnormal.

9. The method according to claim 8, further comprising after initializing the indoor expansion valve:
measuring the indoor unit pipe temperature the air conditioner is operating after the initialization of the indoor expansion valve;
actuating the indoor expansion valve to a first state; and
detecting whether or not a variation of the indoor unit pipe temperature is abnormal by measuring the indoor unit pipe temperature after actuating the indoor expansion valve to the first state.

10. The method according to claim 9, further comprising:
actuating the indoor expansion valve to a second state; and
detecting whether or not a variation of the indoor unit pipe temperature is abnormal by measuring the indoor unit pipe temperature after the opening of the indoor expansion valve.

11. The method according to claim 9, further comprising warning that the indoor expansion valve is malfunctioning, if it is detected that the variation of the indoor unit pipe temperature is abnormal.

12. An air conditioner comprising:
an indoor heat exchanger including a refrigerant that exchanges heat with indoor air;
an indoor expansion valve connected to the indoor heat exchanger to control refrigerant flow; and
a control unit that detects whether or not the indoor expansion valve is malfunctioning by measuring an indoor unit pipe temperature to the indoor heat exchanger while actuating the indoor expansion valve to a first state.

13. The air conditioner according to claim 12, wherein the control unit detects whether or not the indoor expansion valve is malfunctioning through a variation of the indoor unit pipe temperature.

14. The air conditioner according to claim 12, further comprising an indoor temperature sensor to measure a temperature of the indoor air,
wherein the control unit detects whether or not the indoor expansion valve is malfunctioning by measuring a variation of a difference between the indoor unit pipe temperature and the indoor air temperature while actuating the indoor expansion valve to the first state.

15. The air conditioner according to claim 12, further comprising an indoor inlet pipe temperature sensor to measure the indoor unit pipe temperature, which is a temperature of the refrigerant fed into the indoor heat exchanger.

16. The air conditioner according to claim 12, further comprising an indoor outlet pipe temperature sensor to measure the indoor unit pipe temperature, which is a temperature of the refrigerant discharged from the indoor heat exchanger.

17. The air conditioner according to claim 12, wherein the control unit detects whether or not the indoor expansion valve is malfunctioning by measuring the indoor unit pipe temperature while actuating the indoor expansion valve to a second state.

18. The air conditioner according to claim 10, wherein the control unit initializes the indoor expansion valve, if a variation of the indoor unit pipe temperature obtained by measuring the indoor unit pipe temperature while actuating the indoor expansion valve is abnormal.

19. The air conditioner according to claim 18, wherein the control unit provides a warning that the indoor expansion valve is malfunctioning, if a variation of the indoor unit pipe temperature is abnormal while actuating the initialized indoor expansion valve.

20. The air conditioner according to claim 18, wherein the initialization of the indoor expansion valve is initialization of an open state of the indoor expansion valve.

21. The air conditioner according to claim 18, wherein the initialization of the indoor expansion valve is achieved by completely opening the indoor expansion valve and then completely closing the indoor expansion valve.

22. A method for detecting a malfunction of an air conditioner comprising:
continuously measuring an indoor unit pipe temperature around an indoor heat exchanger during operation of the air conditioner;
actuating an indoor expansion valve connected to the indoor heat exchanger to a first state; and
detecting whether or not a variation of the indoor unit pipe temperature is abnormal by measuring the indoor unit pipe temperature after actuating the indoor expansion valve to the first state.
